(19) United States
(12) Patent Application Publication
(10) Pub. No.: US 2015/0278707 A1
(43) Pub. Date: Oct. 1, 2015

(54) PREDICTIVE SPACE AGGREGATED REGRESSION

(71) Applicant: International Business Machines Corporation, Armonk, NY (US)

(72) Inventors: David J. Beymer, San Jose, CA (US); Karen W. Brannon, Palo Alto, CA (US); Ting Chen, Sunnyvale, CA (US); Ritwik K. Kumar, Sunnyvale, CA (US); Tanveer Syeda-Mahmood, Cupertino, CA (US)

(73) Assignee: International Business Machines Corporation, Armonk, NY (US)

(21) Appl. No.: 14/230,400

(22) Filed: Mar. 31, 2014

(51) Int. Cl. G06N 99/00; G06N 7/00

(52) U.S. Cl. CPC G06N 99/005; G06N 7/00

(57) ABSTRACT

Embodiments relate to creating a classification rule by combining classifiers. Aspects include receiving N training samples d, wherein each of the N training samples d includes a label l, receiving T classifiers C, and initializing a first random weight vector α for the N training samples d. Aspects also include initializing a second random weight vector β for the T classifiers C and creating, by a processor, the classification rule by identifying a combination of one or more of the T classifiers C that best approximates the label l for each of the N training samples d based on the first random weight vector and the second random weight vector β.

### STATEMENT REGARDING PRIOR DISCLOSURES BY THE INVENTOR OR A JOINT INVENTOR

The following disclosure(s) are submitted under 35 U.S.C. 102(b)(1)(A): PSAR: Predictive Space Aggregated Regression and its Application in Valvular Heart Disease Classification, Ting Chen, Ritwik Kumar, Guillaume Troianowski, Tanveer Syeda-Mahmood, David Beymer, Karen Brannon, Apr. 7, 2013, 2013 IEEE International Symposium on Biomedical Imaging.

### BACKGROUND

Embodiments of the invention relate generally to predictive space aggregated regression, and more specifically, to using predictive space aggregated regression to create a highly accurate classification rule.

In general, the classification of medical images, such as coronary angiograms, continuous wave flow Doppler images, and the like, is a complex and time consuming problem. Recently, work has been done to attempt to automate the classification of such images. Typically, the classification of such images includes a wide range of classifiers that can be used to solve a classification problem. These classifiers can be generally grouped into, weak, moderate and strong classifiers based on the level of accuracy of the classifiers. Currently, various methods of combining classifiers to develop highly accurate classification rules are known.

Boosting is a known method of finding a highly accurate classification rule by combining many weak classifiers, each of which is only moderately accurate. Typically, each weak hypothesis is a simple rule which can be used to generate a predicted classification for any instance. A common form of boosting, referred to as Adaboost, uses a weighted linear combination of weak classifier for building the string classifier. Recently, an alternative technique for combining weak classifiers, called CAVIAR, was proposed. CAVIAR uses a weighted combination of each weak classifier and training data. While CAVIAR is superior to traditional boosting, it requires learning a large number of parameters, which effectively limits the number of weak classifiers it can combine.

### BRIEF SUMMARY

Embodiments include a method, system, and computer program product for creating a classification rule by combining classifiers. The method includes receiving N training samples d, wherein each of the N training samples d includes a label l, receiving T classifiers C, and initializing a first random weight vector α for the N training samples d. The method also includes initializing a second random weight vector β for the T classifiers C and creating, by a processor, the classification rule by identifying a combination of one or more of the T classifiers C that best approximates the label l for each of the N training samples d.

Additional features and advantages are realized through the techniques of the present disclosure. Other embodiments and aspects of the disclosure are described in detail herein. For a better understanding of the disclosure with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other features, and advantages of the disclosure are apparent from the following detailed description taken in conjunction with the accompanying drawings in which:

FIG. 1 depicts a process flow for creating a classification rule by combining classifiers in accordance with an embodiment.

FIG. 2 depicts a weight matrix that corresponds to training samples and weak learners for creating a classification rule in accordance with an embodiment.

FIG. 3 depicts pseudo code for a predictive space aggregated regression algorithm in accordance with an embodiment.

FIG. 4 depicts pseudo code for an expectation-maximization algorithm for solving for the combination weights α and β in accordance with an embodiment.

FIG. 5A depicts a bar chart illustrating a classification error rate of a predictive space aggregated regression algorithm in accordance with an embodiment.

FIG. 5B depicts a bar chart illustrating a classification error rate of a CAVIAR algorithm.

FIG. 5C depicts a bar chart illustrating a classification error rate of a Adaboost algorithm.

FIG. 6 depicts a processing system for practicing the teachings herein in accordance with an embodiment.

### DETAILED DESCRIPTION

Embodiments described herein are directed to methods, systems and computer program products for creating a classification rule by combining weak classifiers. In exemplary embodiments, a predictive space aggregated regression (PSAR) algorithm is used to create the classification rule. PSAR is an improved boosting algorithm which can be used to combine existing classifiers to improve their performance. In exemplary embodiments, PSAR learns one weight per weak classifier and training sample, as opposed to a weight for each combination of weak classifier and training samples as done by CAVIAR. For example, in a data set with m weak classifiers and n training samples, CAVIAR would learn m×n weights while PSAR would only need to learn m+n weights. In exemplary embodiments, the reduced number of parameters, or classification weights, leads to a more stable numerical solution and allows for a large number of weak classifier to be combined.

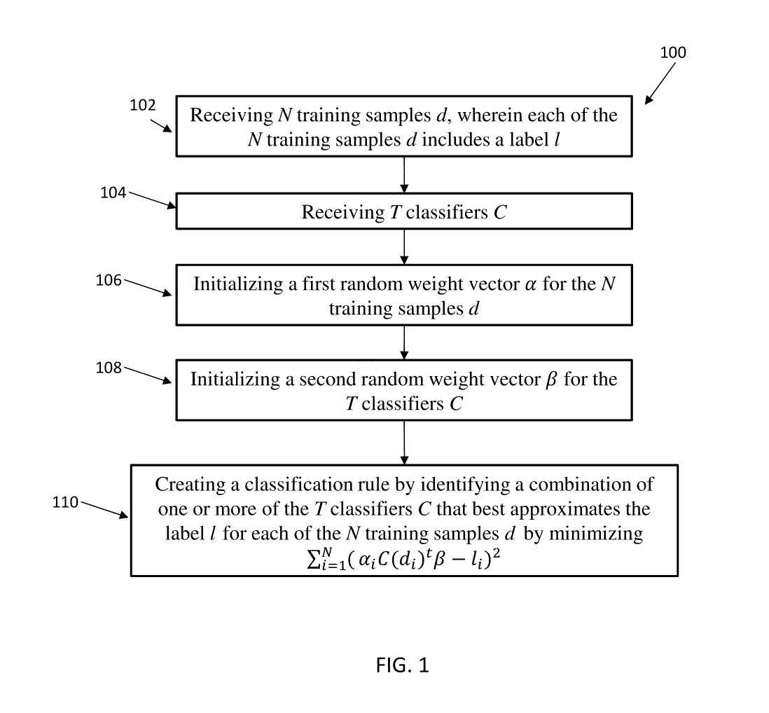

Referring now to FIG. 1, a process flow of a method 100 for creating a classification rule by combining classifiers in accordance with an embodiment is illustrated. As illustrated at block 102, the method 100 begins by receiving N training samples d, wherein each of the N training samples d includes a label l. Next, as shown at block 104, the method 100 includes receiving T classifiers C. The method 100 also includes initializing a first random weight vector α for the N training samples d, as shown at block 106. Next, as shown at block 108, the method 100 includes initializing a second random weight vector β for the T classifiers C. As illustrated at block 110, the method 100 includes creating, by a processor, the classification rule by identifying a combination of one or more of the T classifiers C that best approximates the label l for each of the N training samples d by minimizing

$${\sum }_{i = 1}^{N} {( {α}_{i} {C ( {d}_{i} )}^{t} β - {l}_{i} )}^{2} .$$

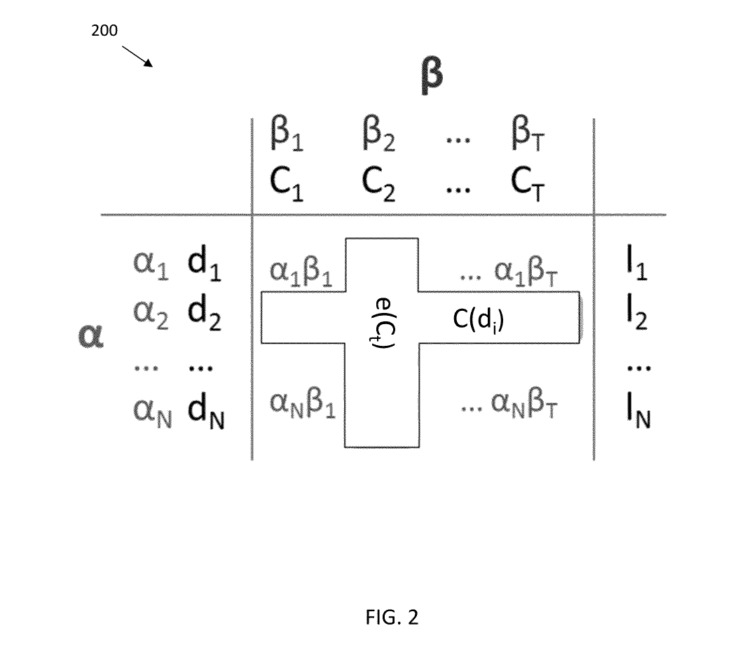

Let [symbol] be the set of training samples and [symbol] be the set of labels which contains only {1, −1} for binary classification. (dᵢ,lᵢ), i=1, . . . , N are random samples drawn from the set [symbol] × [symbol] . Assume Cₜ, t=1, . . . , T are the weak classifiers applied to the instance taken from the data set [symbol] . The magnitude |Cₜ| denotes the confidence of the prediction and its sign distinguishes the class to which it belongs. As shown in FIG. 2, let αᵢ, i=1, . . . , N be the weights corresponding to the training data dᵢ, i=1, . . . , N and let βₜ, t=1, . . . , T be the weights that are associated with the T weak classifiers. To simplify notation, denote α=[α₁, α₂, . . . , α_{N}]^{t} and β=[β₁, β₂, . . . , β_{T}]^{t}. C(dᵢ) be the set of weak classifier outputs corresponding to the i^{th} training sample and e(Cₜ) is the set of outputs from applying the t^{th} weak classifier to all the training data. In exemplary embodiments, the weight matrix that corresponds to both the training samples and weak learners is constructed through the outer product of the two weight vectors α and β, ie. α [symbol] β. In exemplary embodiments, the number of parameters that need to be learned by the model becomes N+T.

In exemplary embodiments, a combination of the weak learners' outputs Cₜ that best approximates the ground truth label lᵢ for each training data dᵢ is found minimizing the overall error of

$${\sum }_{i = 1}^{N} {( {α}_{i} {C ( {d}_{i} )}^{t} β - {l}_{i} )}^{2} .$$

In exemplary embodiments, regularization is needed to solve this under-determined linear system and prevent overfitting. If the behaviors of all the weak classifiers are similar for the training data dᵢ and dⱼ (the i,j^{th} rows in FIG. 2), it can be assumed that the combination strategies for both training samples should also be similar, hence the weights αᵢ and αⱼ should be close to each other. In addition, the behavioral similarity of each weak classifier can be identified by investigating the individual weak learner's output from the whole training data set. For example, if the two classifiers Cₚ and C_{q} have similar outputs, similar weights βₚ and β_{q} can be assigned to them (the p,q^{th} columns in FIG. 2).

In exemplary embodiments, D(·) is the similarity measure defined on the weak classifiers' outputs. D(C(dᵢ),C(dⱼ)) thus represents the similarity of two data samples while D(e(Cₚ),e(C_{q})) represents the similarity of two weak classifiers. Accordingly, the cost function can be regularized using

$${\sum }_{i = 1}^{N} {\sum }_{j = 1}^{N} D ( C ( {d}_{i} ) , C ( {d}_{j} ) ) {( {α}_{i} - {α}_{j} )}^{2} and$$

$${\sum }_{p = 1}^{T} {\sum }_{q = 1}^{T} D ( e ( {C}_{p} ) , e ( {C}_{q} ) ) {( {β}_{p} - {β}_{q} )}^{2} .$$

In exemplary embodiments, after the training stage, a filtering procedure is imposed during the testing stage in order to construct a data adaptive strong learner based on the given test sample and to reduce the generalization error of the model. In exemplary embodiments, the data set is assumed to be non-independent and identically distributed. Accordingly, only a subset of the training data may exhibit the same distribution as the test sample and only those relevant trained parameters are helpful in the testing.

In exemplary embodiments, sparse weighted selection can be used for finding the most relevant training samples given a test data. In one embodiment, a testing stage of the PSAR algorithm includes defining a matrix A with N columns where the i^{th} column is the feature vector of dᵢ and let Y be the feature vector of the given test sample. The sparse combination weights τ can be obtained by solving τ*=argmin_{τ}| [symbol] Aτ−Y [symbol] |₂²+ν| [symbol] τ [symbol] |₁. The classifier H for that certain test data dₒ can be constructed using

$$H ( {d}_{0} ) = sign ( {\sum }_{i = 1}^{N} {τ}_{i} {α}_{i} {\sum }_{t = 1}^{T} {β}_{t} {C}_{t} ( {d}_{0} ) ) .$$

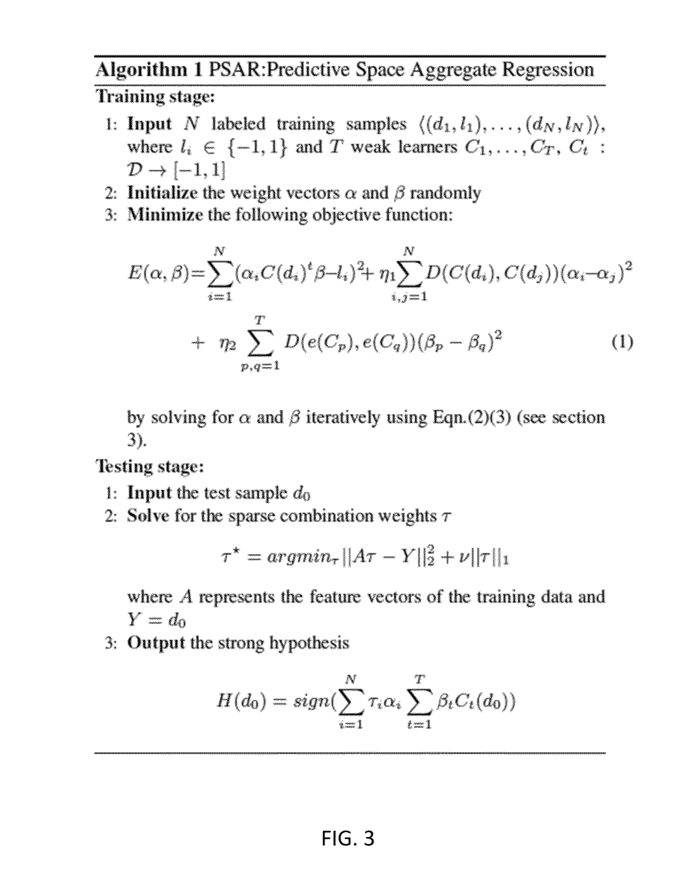

Here α and β are the weights obtained from the training. Due to the L_{τ} norm constraint of τ, the solution is a sparse vector. A pseudo code of an exemplary PSAR algorithm is shown in FIG. 3.

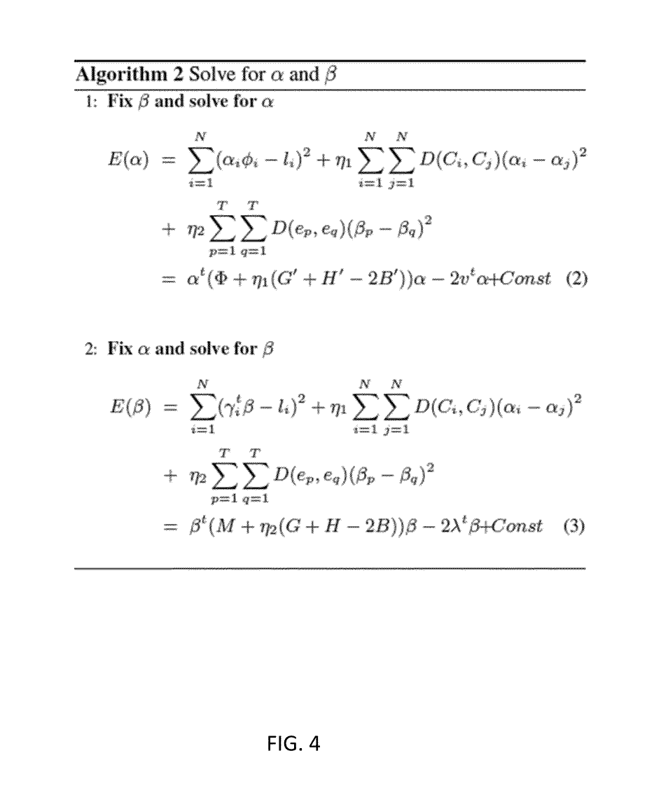

As shown in FIG. 4, a pseudo code algorithm is provide for solving for the combination weights α and β. Starting from the cost function in Eqn. (1) shown in FIG. 3 and adopting the following notations: γᵢ=αᵢCₜ=C(dᵢ); e_{q}=e(C_{q});

φᵢ=C(dᵢ)^{t}β;

$${λ}_{T \times 1} = {\sum }_{i}^{N} {l}_{i} {γ}_{i} ; {M}_{T \times T} = {\sum }_{i}^{N} {γ}_{i} {γ}_{i}^{t} ;$$

G_{T×T}=matrix has D(dᵢ,d₁)+ . . . +D(dᵢ,d_{T}) in the i^{th} diagonal; H_{T×T}=matrix has D(d₁,dᵢ)+ . . . +D(d_{T},dᵢ) in the i^{th} diagonal; B_{T×T}=matrix has D(dᵢ,dⱼ) in (i,j)^{th} entry; G′, H′, B′=matrices with the same formats as G, H, and B, but defined on D(Cᵢ,Cⱼ); Φ_{N×M}=matrix has φᵢ² in i^{th} diagonal; ν_{N×t}=[φ₁l₁,φ₂l₂, . . . , φ_{N}l_{N}]^{t}. In exemplary embodiments, the expectation/maximization like algorithm, as shown in FIG. 4, is used to solve for α and β iteratively until convergence. In both cases, the optimization problems include solving the linear system Ax=b with A being the matrices of Φ+η₁(G′+H′−2B′) and M+η₂(G+H−2B) in the previous equations and b being ν and λ.

In order to demonstrate the PSAR algorithm, simple weak learners were chosen by randomly selecting a dimension from the feature vector and picking a random threshold. The instances are assigned to particular classes based on their values in that chosen feature dimension by comparing to the random threshold. For example, if the feature value in that dimension is larger than the threshold, the subject is classified to class 1, otherwise, it is classified to class −1.

In continuous wave Doppler images, the functioning of the heart valves are indicated by the shapes of the Doppler signal tracings, i.e., the envelopes of the velocity. These shape patterns of the velocity region in Doppler image has been studied for the valvular disease diagnosis and it has shown promising results in decision support. Due to the normalized envelope used, the information of the severity of the diseases conveyed by the peak velocity is no longer captured. In exemplary embodiments, a more challenging problem of classifying the severity of the diseases by using the un-normalized envelope as well as the local intensity variation as our feature can be performed using PSAR.

The continuous wave Doppler image data set containing the subjects of 51 Mitral Regurgitation (MR), 24 Aortic Stenosis (AS), 98 Mitral Stenosis (MS) and 85 Aortic Regurgitation (AR) with both EKG and envelope presented were used as a training data set. Each consists of different degrees of severity varying from mild, moderate to severe. The free parameters involved in the PSAR algorithm include the regularization parameters, η₁, η₂ in the training stage, and ν in the testing. The experiments indicate that the PSAR algorithm is not very sensitive to the choice of these parameters. In all the comparison experiments, η₁ and η₂ were both set to 0.01 and ν was set to 5. Euclidean distance was used for computing classifier-classifier and data-data distances used in regularization. To demonstrate the advantage of PSAR in terms of combining weak classifier, a comparison with a traditional boosting algorithm, such as Adaboost, and CAVIAR on valvular disease classification was performed.

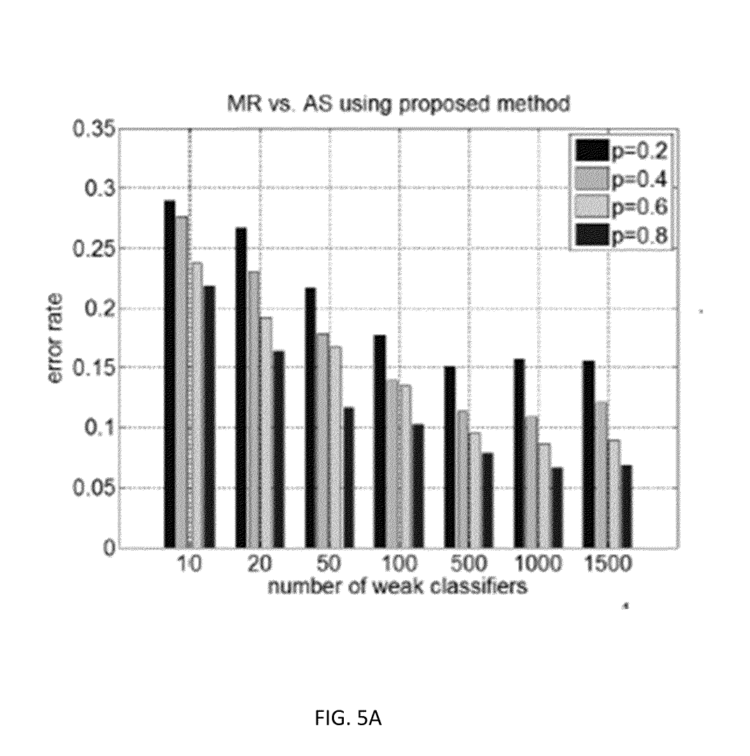

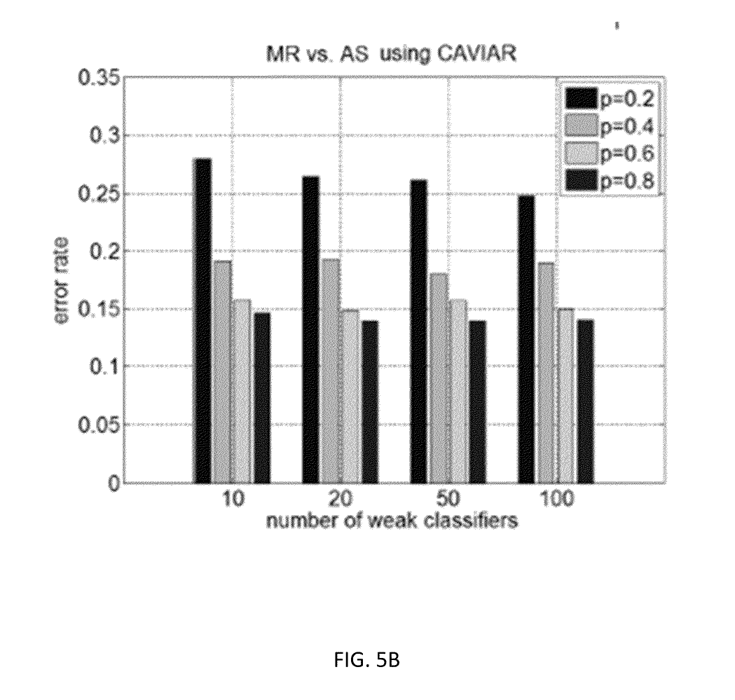

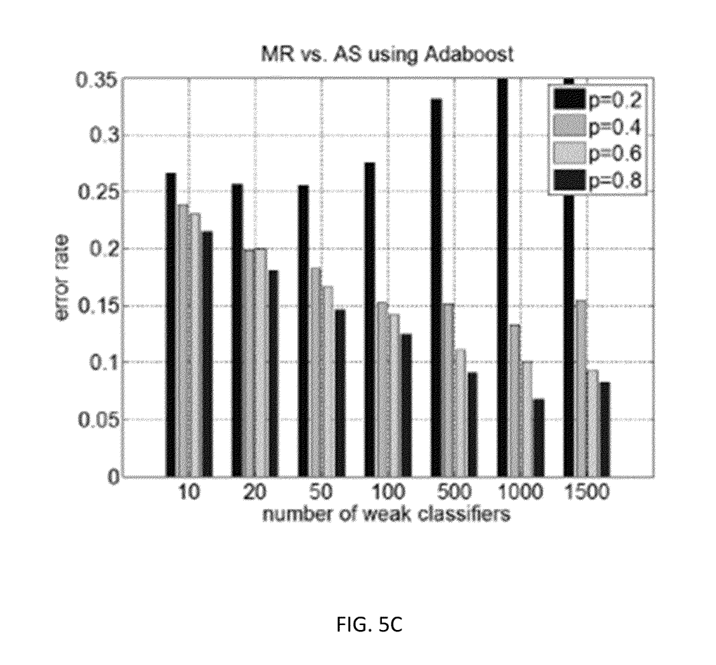

p={20,40,60,80}% portion of the data set were randomly selected for training and the rests are for testing and the number of weak classifiers was varied within
w={10,20,50,100,500,1000,1500}. FIGS. 5A-5C illustrates the classification error rate of PSAR and 2 competing approaches, CAVIAR and Adaboost, respectively. Classification error is measured by the number of mis-classified test samples divided by the total number of test data samples. For each setting of [p, w], the algorithm was repeated 100 times and the average error rate was recorded. The experimental results demonstrated that the PSAR algorithm significantly improves the performances of the weak classifiers and successfully solves the over fitting problem.

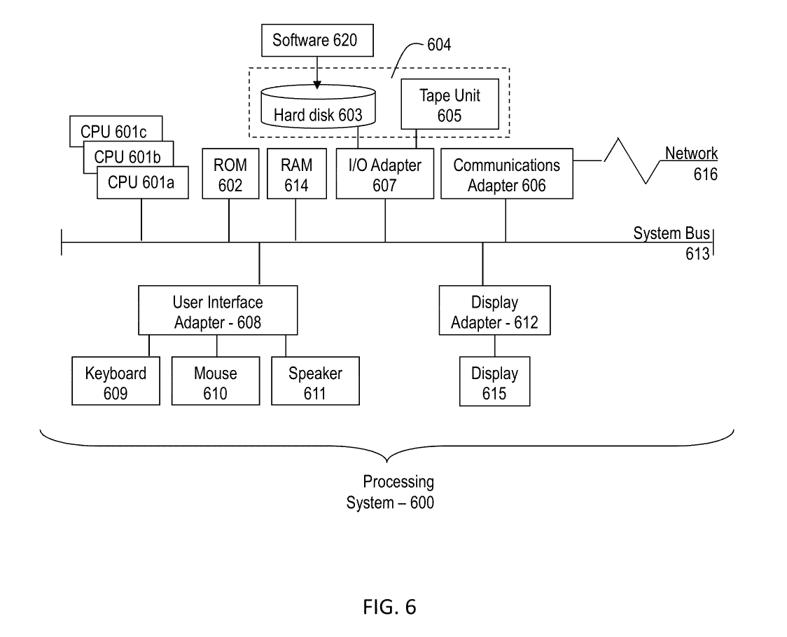

Referring to FIG. 6, there is shown an embodiment of a processing system 600 for implementing the teachings herein. In this embodiment, the system 600 has one or more central processing units (processors) 601a, 601b, 601c, etc. (collectively or generically referred to as processor(s) 601). In one embodiment, each processor 601 may include a reduced instruction set computer (RISC) microprocessor. Processors 601 are coupled to system memory 614 and various other components via a system bus 613. Read only memory (ROM) 602 is coupled to the system bus 613 and may include a basic input/output system (BIOS), which controls certain basic functions of system 600.

FIG. 6 further depicts an input/output (I/O) adapter 607 and a network adapter 606 coupled to the system bus 613. I/O adapter 607 may be a small computer system interface (SCSI) adapter that communicates with a hard disk 603 and/or tape storage drive 605 or any other similar component. I/O adapter 607, hard disk 603, and tape storage device 605 are collectively referred to herein as mass storage 604. Software 620 for execution on the processing system 600 may be stored in mass storage 604. A network adapter 606 interconnects bus 613 with an outside network 616 enabling data processing system 600 to communicate with other such systems. A screen (e.g., a display monitor) 615 is connected to system bus 613 by display adaptor 612, which may include a graphics adapter to improve the performance of graphics intensive applications and a video controller. In one embodiment, adapters 607, 606, and 612 may be connected to one or more I/O busses that are connected to system bus 613 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 613 via user interface adapter 608 and display adapter 612. A keyboard 609, mouse 160, and speaker 611 all interconnected to bus 613 via user interface adapter 608, which may include, for example, a Super I/O chip integrating multiple device adapters into a single integrated circuit.

Thus, as configured in FIG. 6, the system 600 includes processing capability in the form of processors 601, storage capability including system memory 614 and mass storage 604, input means such as keyboard 609 and mouse 160, and output capability including speaker 611 and display 615. In one embodiment, a portion of system memory 614 and mass storage 604 collectively store an operating system such as the AIX® operating system from IBM Corporation to coordinate the functions of the various components shown in FIG. 6.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

Further, as will be appreciated by one skilled in the art, aspects of the present disclosure may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for creating a classification rule by combining classifiers comprising:
receiving N training samples d, wherein each of the N training samples d includes a label l;
receiving T classifiers C;
initializing a first random weight vector α for the N training samples d;
initializing a second random weight vector β for the T classifiers C;
creating, by a processor, the classification rule by identifying a combination of one or more of the T classifiers C that best approximates the label l for each of the N training samples d based on the first random weight vector and the second random weight vector β.

2. The method of claim 1, identifying the combination of one or more of the T classifiers C that best approximates the label l for each of the N training samples d is performed by minimizing
$${\sum }_{i = 1}^{N} {( {α}_{i} {C ( {d}_{i} )}^{t} β - {l}_{i} )}^{2} .$$

3. The method of claim 1, wherein each of the labels l consists of a −1 or a +1 value.

4. The method of claim 1, further comprising determining a similarity D of a first classifiers Cₚ and a second classifier C_{q} by taking a dot product of Cₚ and C_{q}

5. The method of claim 4, wherein identifying the combination of one or more of the T classifiers C that best approximates the label l further comprises minimizing
$${\sum }_{i = 1}^{N} {\sum }_{j = 1}^{N} D ( C ( {d}_{i} ) , C ( {d}_{j} ) ) {( {α}_{i} - {α}_{j} )}^{2} .$$

6. The method of claim 1, wherein e(Cₜ) is a set of output from applying the t^{th} classifier Cₜ to all the training samples d.

7. The method of claim 6, further comprising determining a similarity D of a first sample e(Cₚ) and a second sample e(C_{q}) by taking a dot product of e(Cₚ) and e(C_{q}).

8. The method of claim 7, wherein identifying the combination of one or more of the T classifiers C that best approximates the label l further comprises minimizing
$${\sum }_{p = 1}^{T} {\sum }_{q = 1}^{T} D ( e ( {C}_{p} ) , e ( {C}_{q} ) ) {( {β}_{p} - {β}_{q} )}^{2} .$$

9. A computer program product for creating a classification rule by combining classifiers, the computer program product comprising a computer readable storage medium having program code embodied therewith, the program code executable by a processor to:
receive N training samples d, wherein each of the N training samples d includes a label l;
receive T classifiers C;
initialize a first random weight vector α for the N training samples d;
initialize a second random weight vector β for the T classifiers C;
create the classification rule by identifying a combination of one or more of the T classifiers C that best approximates the label l for each of the N training samples d based on the first random weight vector and the second random weight vector β.

10. The computer program product of claim 9, wherein identifying the combination of one or more of the T classifiers C that best approximates the label l for each of the N training samples d is performed by minimizing
$${\sum }_{i = 1}^{N} {( {α}_{i} {C ( {d}_{i} )}^{t} β - {l}_{i} )}^{2} .$$

11. The computer program product of claim 10, wherein each of the labels l consists of a −1 or a +1 value.

12. The computer program product of claim 10, further comprising determining a similarity D of a first classifiers Cₚ and a second classifier C_{q} by taking a dot product of Cₚ and C_{q}

13. The computer program product of claim 12, wherein identifying the combination of one or more of the T classifiers C that best approximates the label l further comprises minimizing
$${\sum }_{i = 1}^{N} {\sum }_{j = 1}^{N} D ( C ( {d}_{i} ) , C ( {d}_{j} ) ) {( {α}_{i} - {α}_{j} )}^{2} .$$

14. The computer program product of claim 10, wherein e(Cₜ) is a set of output from applying the t^{th} classifier Cₜ to all the training samples d.

15. The computer program product of claim 14, further comprising determining a similarity D of a first sample e(Cₚ) and a second sample e(C_{q}) by taking a dot product of e(Cₚ) and e(C_{q}).

16. The computer program product of claim 15, wherein identifying the combination of one or more of the T classifiers C that best approximates the label l further comprises minimizing
$${\sum }_{p = 1}^{T} {\sum }_{q = 1}^{T} D ( e ( {C}_{p} ) , e ( {C}_{q} ) ) {( {β}_{p} - {β}_{q} )}^{2} .$$

17. A system for creating a classification rule by combining classifiers comprising:
a memory having computer readable computer instructions; and
a processor for executing the computer readable instructions, the instruction including:
receiving N training samples d, wherein each of the N training samples d includes a label l;
receiving T classifiers C;
initializing a first random weight vector α for the N training samples d;
initializing a second random weight vector β for the T classifiers C;
creating, by a processor, the classification rule by identifying a combination of one or more of the T classifiers C that best approximates the label l for each of the N training samples d based on the first random weight vector and the second random weight vector β.

18. The system of claim 17, wherein identifying the combination of one or more of the T classifiers C that best approximates the label l for each of the N training samples d is performed by minimizing
$${\sum }_{i = 1}^{N} {( {α}_{i} {C ( {d}_{i} )}^{t} β - {l}_{i} )}^{2} .$$

19. The system of claim 17, further comprising determining a similarity D of a first classifiers Cₚ and a second classifier C_{q} by taking a dot product of Cₚ and C_{q}

20. The system of claim 19, wherein identifying the combination of one or more of the T classifiers C that best approximates the label l further comprises minimizing
$${\sum }_{i = 1}^{N} {\sum }_{j = 1}^{N} D ( C ( {d}_{i} ) , C ( {d}_{j} ) ) {( {α}_{i} - {α}_{j} )}^{2} .$$
